(19) United States
(12) Patent Application Publication
(10) Pub. No.: US 2018/0217666 A1
(43) Pub. Date: Aug. 2, 2018

(54) BIOMETRIC CONTROL SYSTEM

(71) Applicant: NEUROVERSE, INC., San Diego, CA (US)

(72) Inventors: Ricardo GIL DA COSTA, San Diego, CA (US); Michael Christopher BAJEMA, San Diego, CA (US)

(21) Appl. No.: 15/883,057

(22) Filed: Jan. 29, 2018

Related U.S. Application Data
(60) Provisional application No. 62/452,350, filed on Jan. 30, 2017.

(51) Int. Cl. G06F 3/01; A63F 13/212; A63F 13/837; A63F 13/42; A63F 13/213

(52) U.S. Cl. CPC G06F 3/015; G06F 3/012; G06F 3/013; A63F 13/212; A63F 13/92; A63F 13/42; A63F 13/213; A63F 2300/8082; A63F 2300/8076; A63F 13/837

(57) ABSTRACT

A biometric control device is described. The biometric control device may include a data acquisition unit configured to detect a biometric signal from a user in an environment. biometric control device may also include a data processing unit configured to process the biometric signal detected from the user. The data processing unit may be further configured to compute a biometric control signal configured to modulate a set of actions and/or objects in the environment.

### CROSS-REFERENCE TO RELATED APPLICATION

This application claims the benefit of U.S. Provisional Patent Application No. 62/452,350, filed on Jan. 30, 2017, entitled “BIOMETRIC CONTROL SYSTEMS,” the disclosure of which is expressly incorporated by reference herein in its entirety.

### BACKGROUND

### Field

Certain aspects of the present disclosure generally relate to methods for biometric controls that may stand alone or augment existing controls. Controls may be used in/with virtual reality (VR), augmented reality (AR), gaming (mobile, PC, or console), mobile devices, or in a physical space with physical devices.

### Background

Control systems that use buttons, levers, or joysticks are limited in complexity by the physical characteristics of the user. A human only has so many fingers and can only move their limbs from one position to another with limited speed. Moreover, disabled users may have trouble using traditional systems. A way of augmenting control systems with new control mechanisms for allowing more control options is advantageous for both able-bodied and disabled users.

Realization of virtual reality (VR) movement is quite limited. First, many systems are limited to the physical space the VR sensors can reliably pick up a user. Second, many systems have no way of tracking the user's location. As a result, large game worlds are difficult to traverse naturally and often involve additional control methods. One control method is using a joystick to translate a player's location. This method works well when the player is sitting down or the game is designed to feel like the player is in a vehicle. Unfortunately, using a joystick may induce motion sickness when the player is standing or if the game's movement controls are not well designed.

Another method of movement control is using “in game teleportation.” With the teleportation method, the player usually goes through a few methodological steps to achieve movement. First, the player declares an intention of teleporting. This is usually performed by hitting or holding down a button on a controller. Second, the player aims at a target with either their head or with a motion controller. Third, the player declares that he/she wants to teleport to a selected location to which they have aimed. This is usually done by hitting or releasing a button on the controller. Finally, the player arrives at the target destination.

Unfortunately, the in game teleportation method is limited to systems with controllers or other input devices. Furthermore, this teleportation method limits the number of controller buttons available for other aspects of the game/interactive environment. In addition, the player is often forced to make a large physical commitment of pointing their body, controller, or head in a direction of travel. Another method for movement uses a treadmill for allowing the player to walk in place. This method provides a more natural feeling compared to the two prior methods but involves cumbersome and expensive equipment. These treadmill movement systems are also not compatible with all types of VR systems.

There is a current and urgent need for a movement control system that can address many of these drawbacks.

### SUMMARY

A biometric control device is described. The biometric control device may include a data acquisition unit configured to detect a biometric signal from a user in an environment. biometric control device may also include a data processing unit configured to process the biometric signal detected from the user. The data processing unit may be further configured to compute a biometric control signal configured to modulate a set of actions and/or objects in the environment.

A method of a biometric control system is described. The method may include detecting a first biometric signal from a first user in an environment. The method may also include modulating a set of actions and/or objects in the environment according to the first biometric signal detected from the first user.

A biometric control system is further described. The biometric control device may include means for detecting a biometric signal from a user in an environment. The biometric control device may also include means for modulating a set of actions and/or objects in the environment according to the biometric signal detected from the user

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1A shows a typical workflow for using biometric controls while FIG. 1B lists many potential aspects of these controls.

FIGS. 2A and 2B illustrate block diagrams of biometric control devices, according to aspects of the present disclosure.

FIG. 3 illustrates a block diagram of an exemplary data processing unit, according to aspects of the present disclosure.

FIG. 4A shows a block diagram of a basic biometric trigger mechanism, and FIG. 4B shows a specific instance of the basic biometric trigger mechanism for using double blinks to fire a weapon, according to aspects of the present disclosure.

FIGS. 5A-5D show blocks using the basic biometric trigger as shown in FIG. 2 with screenshots depicting an exemplary game, according to aspects of the present disclosure.

FIG. 6A shows an example of a basic teleport where a biometric trigger may be used, and FIG. 6B shows an example of basic teleporting using a double blink as a trigger, according to aspects of the present disclosure.

FIG. 7 shows a way of combining and deciding between the methods in FIG. 6B and FIG. 4B, according to aspects of the present disclosure.

FIG. 8 modifies FIG. 7 by adding a distance control decision mechanism that allows a player to fire their weapon instead of teleporting when looking at the floor if it is farther than distance x away, according to aspects of the present disclosure.

FIG. 9 modifies FIG. 8 by adding an indicator to let the player know when and if they can teleport, for example, using the double blink trigger mechanism, according to aspects of the present disclosure.

FIGS. 10A, 10B, 11A, 11B, and 12 show an exemplary virtual reality (VR) game, as an implementation of the indicator mechanism of FIG. 9, according to aspects of the present disclosure.

FIG. 13A shows a block diagram of a basic biometric indicator using a biometrics' magnitude methodology, and FIG. 13B shows a block diagram of a basic biometric indicator that involves a trigger, according to aspects of the present disclosure.

FIGS. 14A-14C show examples of FIG. 6A, with screenshots depicting the detecting of a magnitude change (from an electroencephalography (EEG) spectral analysis) leading to an observable correlated modification of the color of an object in an exemplary VR game, according to aspects of the present disclosure.

FIG. 15A shows a block diagram for motion control to pull an object towards a player using a decision mechanism, according to aspects of the present disclosure.

FIG. 15B shows an example of FIG. 15A using the player's gaze as a decision mechanism, according to aspects of the present disclosure.

FIG. 15C shows an example of FIG. 15A using a gesture, hand location, or controller orientation to check if the player is pointing at an object as a decision mechanism, according to aspects of the present disclosure.

FIG. 16 expands FIGS. 15A-15C by adding an indicator to inform the player that an action is taking place or can take place, according to aspects of the present disclosure.

FIGS. 17A and 17B expand FIGS. 15B and 15C, respectively, by adding a biometric operator, an indicator, and threshold control, according to aspects of the present disclosure.

FIGS. 18A and 18B show a VR exemplary game, as a configuration of FIG. 17A with pictures, according to aspects of the present disclosure.

FIG. 19 expands FIG. 17A by adding a decision that involves the user being within a certain distance to pull an object using a biometric magnitude, according to aspects of the present disclosure.

FIGS. 20A and 20B show a VR game environment as a configuration of FIG. 19, according to aspects of the present disclosure.

FIG. 21A shows a block diagram for charging an object, according to aspects of the present disclosure.

FIG. 21B shows a block diagram where player gaze is used as a decision mechanism, in which an indicator is used to indicate a level of charge at any point, according to aspects of the present disclosure.

FIG. 22 is a flowchart that expands FIG. 21B by augmenting the charging by enabling charging speed control by biometric magnitude, according to aspects of the present disclosure.

FIGS. 23A and 23B show the first part of an example with the flowchart of FIG. 22 in an exemplary VR game, in which the player looks at a portal to charge it, according to aspects of the present disclosure.

FIGS. 24A and 24B show the second and last part of an example with the flowchart of FIG. 22 in an exemplary VR game, where the player looks at a portal to charge it, and subsequently enables an additional action, in this case bringing new players to the game, according to aspects of the present disclosure.

FIG. 25 is a flowchart that modifies the charging mechanism as shown in FIG. 22 by giving a time limit for charging an object, according to aspects of the present disclosure.

FIGS. 26A and 26B show a time controlled charge with the flowchart of FIG. 25 in an exemplary VR game, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described herein, the use of the term “and/or” is intended to represent an “inclusive OR”, and the use of the term “or” is intended to represent an “exclusive OR”. As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations.

Realizing movement in a virtual reality (VR) environment is quite limited using conventional control systems that rely on buttons, levers, or joysticks. For example, using a joystick for providing a movement control mechanism may induce motion sickness when the player is standing or if the game's movement controls are not well designed. Another method of movement control is using “in game teleportation.” Unfortunately, the in game teleportation method is limited to systems with controllers or other input devices. Furthermore, this teleportation method limits the number of controller buttons available for other aspects of the game/interactive VR environment. Another method for movement uses a treadmill for allowing a player to walk in place. This method provides a more natural feeling compared to the two prior methods but involves cumbersome and expensive equipment. These treadmill movement systems are also not compatible with all types of VR systems.

According to aspects of the present disclosure, a novel methodology for biometric control systems using a set of biometric signals (e.g., neural signals and head and face muscle signals) for a decision control system is described. In aspects of the present disclosure, biometric signals are used for triggering and modulating a set of actions and object and environment properties in interactive and game experiences.

One exemplary type of biometric signal that can be used in a biometric control system is an electroencephalography (EEG) signal. An EEG signal is the recording of electrical activity exhibited by the brain using electrodes positioned on a subject's head, forming a spectral content of neural signal oscillations that comprise an EEG data set. For example, the electrical activity of the brain that is detected by EEG techniques can include voltage fluctuations that may result from ionic current flows within the neurons of the brain. In some contexts, an EEG signal refers to the recording of the brain's spontaneous electrical activity over specific periods of time.

One example of an EEG technique includes recording event-related potentials (ERPs), which refer to EEG recorded brain responses that are correlated with a given event (e.g., simple stimulation and complex VR environment). For example, an ERP includes an electrical brain response—a brain wave—related to sensory, motor, and/or cognitive processing. ERPs can be associated with brain measures of perception (e.g., visual, auditory, etc.) and cognition (e.g., attention, language, decision making, etc.). A typical ERP waveform includes a temporal evolution of positive and negative voltage deflections, termed “components.” For example, typical components are classified using a letter (N/P: negative/positive) and a number (indicating the latency, in milliseconds from the onset of stimulus event), for which this component arises.

In some implementations, for example, the biometric signals used as a decision metric for the biometric control system can be electromyography (EMG) signals sensed from skeletal muscles (e.g., including facial muscles) of the user. For example, the EMG signals may result from eye blinks of the user, where eye blinks may be in response to an event-related potential based on stimuli presented by a display screen to the user, or by environmental stimuli in the user's environment.

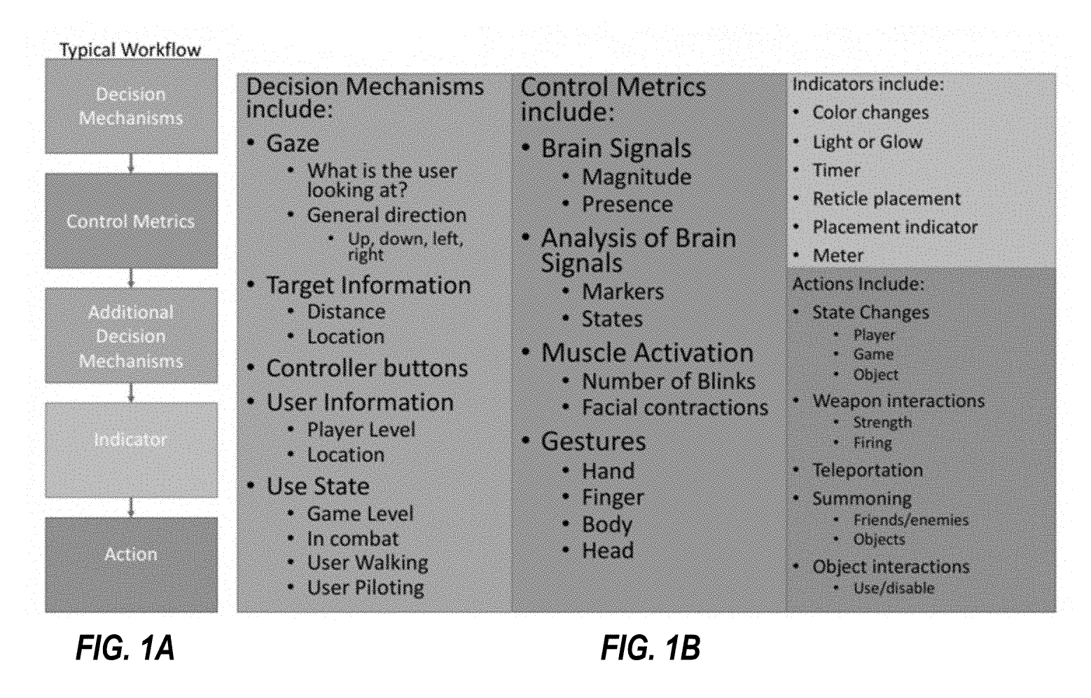

The inventive aspects include control methods that may be used in either a standalone fashion or an addition to augment existing controls in, for example, an interactive VR game environment. In some implementations, the disclosed inventive features use a workflow as shown in FIG. 1A, including decision mechanisms, control metrics, additional decision mechanisms, indicators, and/or actions.

FIG. 1A shows a typical workflow for using biometric controls while FIG. 1B lists many potential aspects of these controls. As shown in FIG. 1A, decision mechanisms are usually determined by input from physical or virtual controllers, the physical or virtual state of an object or user, and information about the user or system. Physical or virtual controllers (where a player may hold and physically interact with real or with virtual versions of these objects) may include the following: game console controllers, keyboards, mice, inputs on virtual reality headsets or devices, buttons, and joysticks. Decision mechanisms that use the physical or virtual state of an object may use the following information: the object's location, orientation, size, appearance, color, weight, distance from user, and distance from another object. Additional decision mechanisms are listed in FIG. 1B, including gaze, target information, controller buttons, user information, and user state.

As further illustrated in FIGS. 1A and 1B, control metrics are differentiated from decision mechanisms by the fact that control metrics typically use sensors that specify more complex analysis. By contrast, decision mechanisms are often synonymous with pressing a button, using a joystick or other sequences of Boolean or scalar logic.

As listed in FIG. 1B, control metrics can include biometric signals, such as brain (e.g., electroencephalography (EEG)) signals, muscle (electromyography (EMG)) signals, behavioral responses (e.g., eye movement, facial movements, and other behaviors) or other signals that can be perceived from a user's body. Control Metrics may also include other behavioral signals such as: hand gestures, body gestures, body location or orientation, hand location or orientation, finger gestures, finger location or orientation, and head location or orientation, as well as another user or player for a multi-user mode or multi-player situations. For example, a mental state of a second user may be determined according to a second biometric signal detected from the second user in the multi-user mode. In this example, displayed attributes of an environment of a first user may be modified according to the mental state of the second user in the multi-user mode.

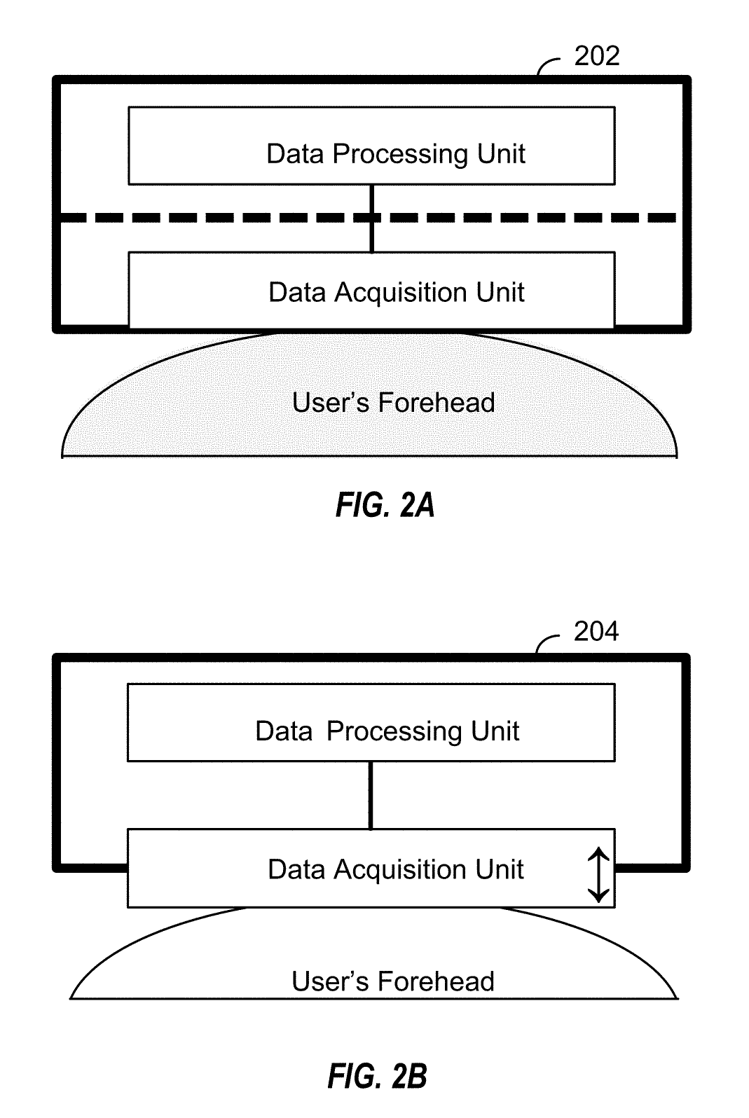

An exemplary device for reading biometric signals, such as a brain signal (EEG), a muscle signal (EMG), behavioral responses (e.g., eye movement, facial movements, and other behaviors) or other signals that can be received from the body as shown in FIGS. 2A and 2B and further described in U.S. patent application Ser. No. 15/314,916, filed on Nov. 29, 2016, entitled “PHYSIOLOGICAL SIGNAL DETECTION AND ANALYSIS SYSTEMS AND DEVICES,” the disclosure of which is expressly incorporated by reference herein in its entirety.

FIGS. 2A and 2B show block diagrams of biometric control devices, according to certain aspects of the present disclosure. An exemplary biometric control device of FIG. 2A includes a data processing unit communicatively coupled to a data acquisition unit configured to contact a user's forehead. The data processing unit is encased in a casing structure 202 or housing. In one aspect of the present disclosure, the data acquisition unit is at least partially encased in the casing structure 202, as shown in FIG. 2A. In other aspects of the present disclosure, the data acquisition unit is attached to a casing structure 204 (e.g., which can be disposable and detachably attached), as shown in FIG. 2B.

In one aspect of the present disclosure, the biometric control device, as shown in FIG. 2A, includes the casing structure 202 configured to include a contact side conformable to the user's forehead. The biometric control device may include a data acquisition unit configured to include one or more sensors to detect electrophysiological (e.g., EEG and/or EMG) signals of a user when the user makes contact with the device. The biometric control device may also include a data processing unit encased within the casing structure 202 and in communication with the data acquisition unit.

In one aspect of the present disclosure, the data processing unit is configured to include a signal processing circuit (e.g., including an amplifier and an analog-to-digital unit) to amplify and digitize the detected electrophysiological signals as data. The data processing unit may also include a processor to process the data, a memory to store the data, and a transmitter to transmit to the data to a remote computer system. The biometric control device may further include a power supply unit encased within the casing structure 202 and electrically coupled to the data processing unit for providing electrical power. The biometric control device may acquire biometric control data from the user.

In aspects of the present disclosure, the biometric control data is used for triggering and modulating a set of actions and object and environment properties in interactive and game experiences. In one aspect of the present disclosure, the biometric control data may be used for triggering environmental changes in a virtual/digital world. For example, a new interactive methodology is described where the whole “world” reacts to the user's mental/neural state, as determined from the biometric control data. In this example, environmental changes in the sky (e.g., from blue to grey to dark to red), the grass (e.g., from green, to brown, to ashes), and/or the environmental sounds (e.g., from windy and stormy, to peaceful, etc.), etc. This type of interactive virtual/digital world may be referred to as a “Mind World.”

For example, the biometric control devices of FIGS. 2A and 2B may be configured to be portable, independently operable, and wirelessly communicative to a remote computer system (e.g., a gaming system, a desktop computer, a VR headset (e.g., including a smartphone), a tablet, a wearable device, and/or a server). In such examples, the biometric control devices can be operable to detect the electrophysiological signals of a user and process the data from the user wearing the device in various unrestrictive environments, such as a VR gaming environment. According to aspects of the present disclosure, the biometric control device may operate in conjunction with a VR headset for simplifying navigation and gaming control in an interactive VR environment. According to other aspects of the present disclosure, features of the biometric control devices are integrated into a VR headset.

In aspects of the present disclosure, a biometric control device may be configured as a portable, independently operable, and wirelessly communicative device, in which the data acquisition unit is non-detachably coupled to the contact side of the casing structure. In such examples, the data acquisition unit can be configured to include a moveable electrode containment assembly configured to protrude outwardly and compressibly retract from the casing structure. The moveable electrode containment assembly includes one or more electrodes electrically coupled to the signal processing circuit of the data processing unit by an electrical conduit. In some examples, the detected electrophysiological signals are electromyography (EMG) signals sensed from head muscles of the user associated with the user's eye blinking or facial expressions. In some implementations, for example, this biometric control data is used for navigating and operating in an interactive VR gaming environment.

For example, the biometric control device can further include an eye-tracking unit including an optical sensor for receiving data corresponding to eye blinking of the user as well as a gaze location of the user. For example, the biometric control device can further include a display screen located at a fixed position away from the user when in contact with the section of the housing to assist in an eye-tracking application of the eye-tracking unit. For example, the biometric control information can be processed by a device including a set-top box, and/or a VR headset for navigating the interactive VR gaming environment.

The biometric control device, as shown in FIG. 2B, includes a data processing unit communicatively coupled to a data acquisition unit configured to contact a user's forehead. The data processing unit is encased in a casing structure 204 or housing, and the data acquisition unit is at least partially encased in the casing structure 204. In some aspects of the present disclosure, the data acquisition unit is configured to move with respect to the casing structure 204 (e.g., when a user makes contact with the data acquisition unit to provide suitable contact to the user's forehead with the sensors of the data acquisition unit).

In some aspects of the present disclosure, the data acquisition unit of the biometric control device can include a set of recording electrodes configured about the user's forehead or other regions of the user's head to acquire multiple channels of electrophysiological signals of the user. In one example, two (or more) additional recording electrodes may be arranged linearly with respect to the first recording electrode, ground electrode, and reference electrode arranged in a sagittal direction. In another example, one (or more) additional electrodes can be positioned to the left of the first recording electrode, while other additional recording electrode(s) can be positioned to the right of the first recording electrode.

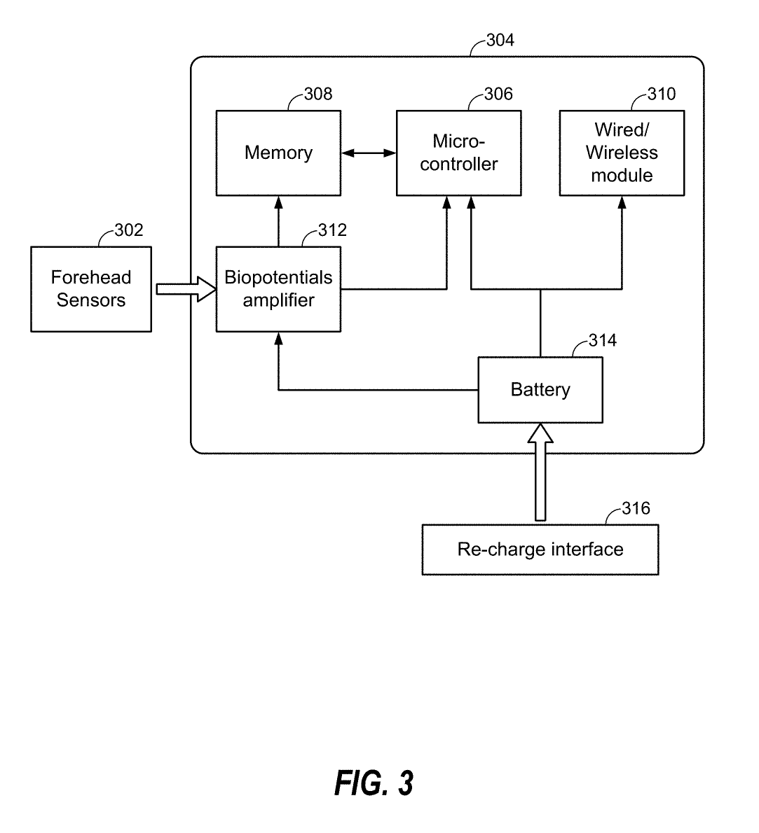

FIG. 3 shows a block diagram of a data processing unit 304 of the disclosed biometric control devices and systems, according to aspects of the present disclosure. In this configuration, the data processing unit 304 includes a processor 306 (e.g., a microcontroller or programmable processor) to process data acquired from a user. The processor is in communication with a memory 308 to store the data, a wired/wireless module 310 (e.g., a Bluetooth/USB module) to transmit and/or receive data, and a signal processing circuit 312 (e.g., a bio-potentials amplifier) to amplify, digitize, and/or condition the acquired physiological data obtained from the user. The data may be received from forehead sensors 302. In one configuration, the wired/wireless module 310 includes a wireless transmitter/receiver (Tx/Rx) device. The data processing unit 304 includes a battery 314 (e.g., a power supply) to supply power to the units of the data processing unit 304. The battery 314 may be connected to a re-charge interface 316. The elements as shown in FIG. 3 may also be defined outside of the data processing unit 304 and/or may be integrated into a VR headset.

Depending on various configurations of the biometric control devices, any sensed biometric signals may be analyzed and used as a control metric in various ways, which may be referred to herein as biometric control signals. The various control metrics, include, but are not limited to: (1) analysis to detect the occurrence and modulation of specific signal features; (2) spectral power and/or amplitude analysis for assessment of signal components magnitude; (3) analysis to detect physiologically relevant states of the user; and (4) state and feature analysis to determine closeness on an actionable scale.

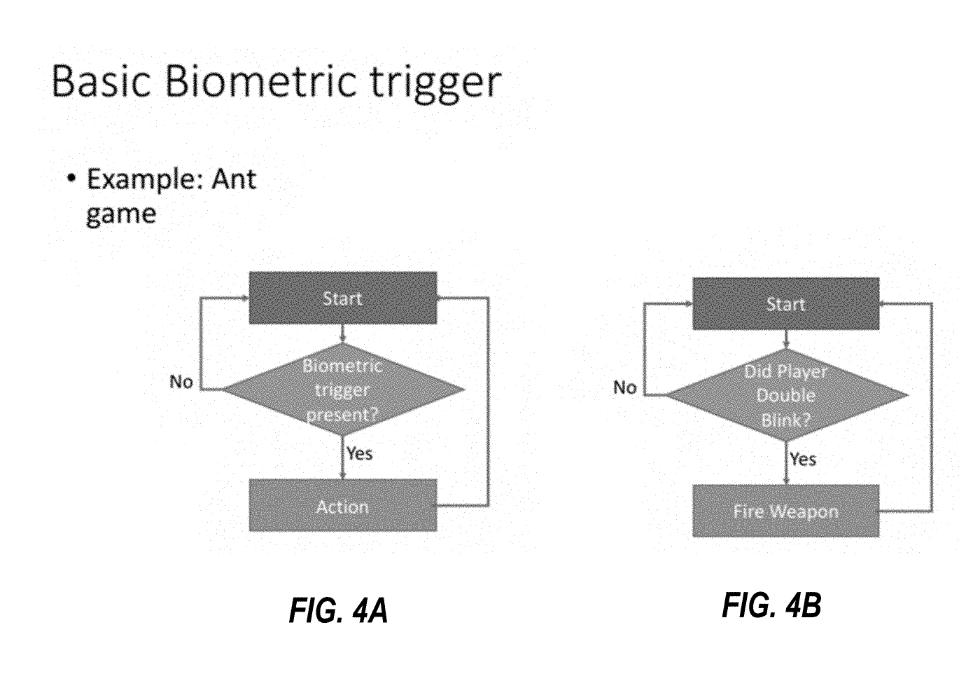

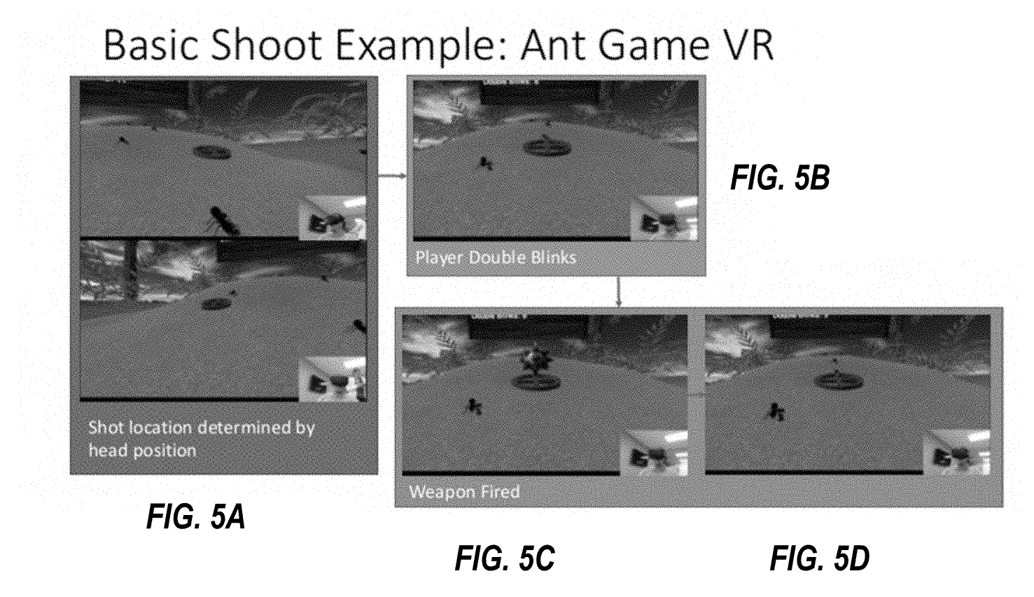

For example, the biometric signals may be used for providing a control metric based on a signal analysis for detecting the occurrence and modulation of specific signal features. One such example of a feature is eye blinking. According to aspects of the present disclosure, a blink (or a predetermined number of blinks) may be used as a trigger type. Exemplary control metrics are shown in FIGS. 4B, 20B, 23A, and 23B. FIG. 4A shows a block diagram of a basic biometric trigger mechanism. FIG. 4B shows a specific instance of a basic biometric trigger mechanism for using double blinks to fire a weapon, for example, as shown in FIGS. 5A-5D.

FIGS. 5A-5D show an application of the basic biometric control trigger mechanism, as shown in FIG. 4B, with screenshots of an exemplary VR game, according to aspects of the present disclosure. As shown in FIG. 5A, a shot location is determined by a head position of the player. In this configuration, the action of “shooting” is being determined (e.g., triggered) by detecting eye-blinks of the user, as shown in FIG. 5B. That is, eye-blink detection functions as a biometric control based on a detected facial feature of the user in this aspect of the present disclosure. As shown in FIGS. 5C and 5D, firing of a user weapon is triggered by a detected double eye-blink of FIG. 5B.

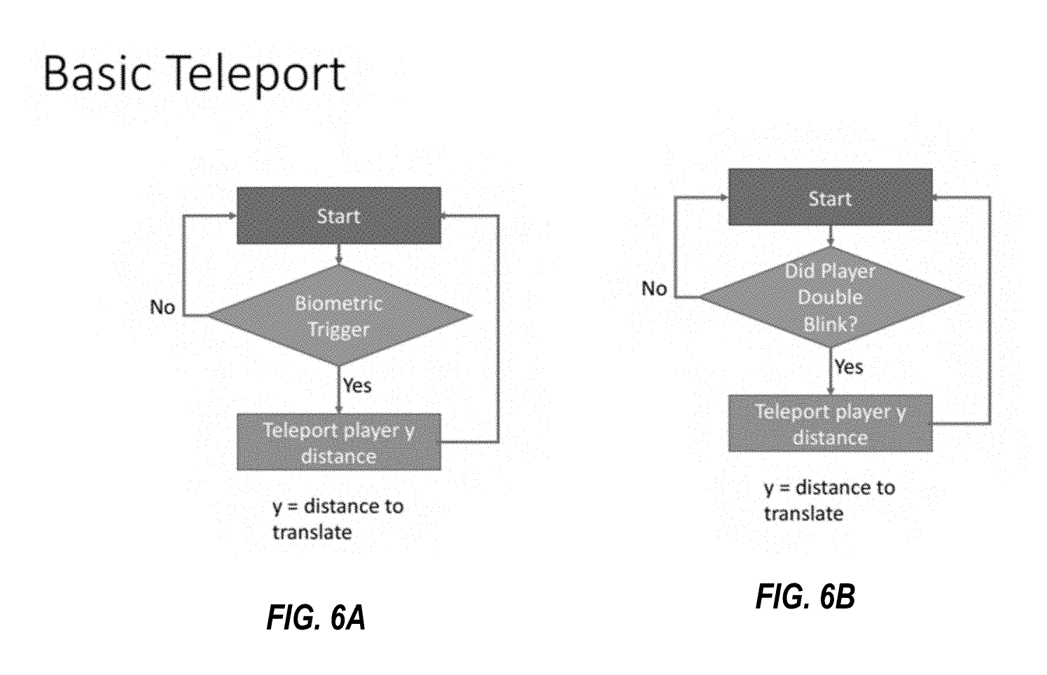

In this example, detected eye-blinks of the player provide a biometric control for controlling a shooting action that is consistently detected from monitoring facial muscles of a user wearing a biometric control device. This type of biometric control is based on a behavioral response of the user. Shooting objects in a VR environment, for example, as shown in FIGS. 5A-5D is just one application of a biometric control while stationary in a VR environment. Unfortunately, navigating in a VR environment is quite limited using conventional control systems that rely on buttons, levers, or joysticks. Aspects of the present disclosure describe a teleport mechanism for navigating a VR environment using various biometric triggers as shown in FIGS. 6A-12.

FIG. 6A shows examples of a basic teleport block diagram where a biometric trigger may be used. FIG. 6B shows an example of basic teleporting using a double blink as a biometric trigger mechanism, according to aspects of the present disclosure. In this example, monitoring facial muscles of a player allows blinking of the player to communicate a biometric trigger. In this example, when a double eye-blink is detected by a biometric control device (see FIGS. 2A and/or 2B) the player is teleported a selected distance (e.g., a y-axis distance to translate in the VR environment).

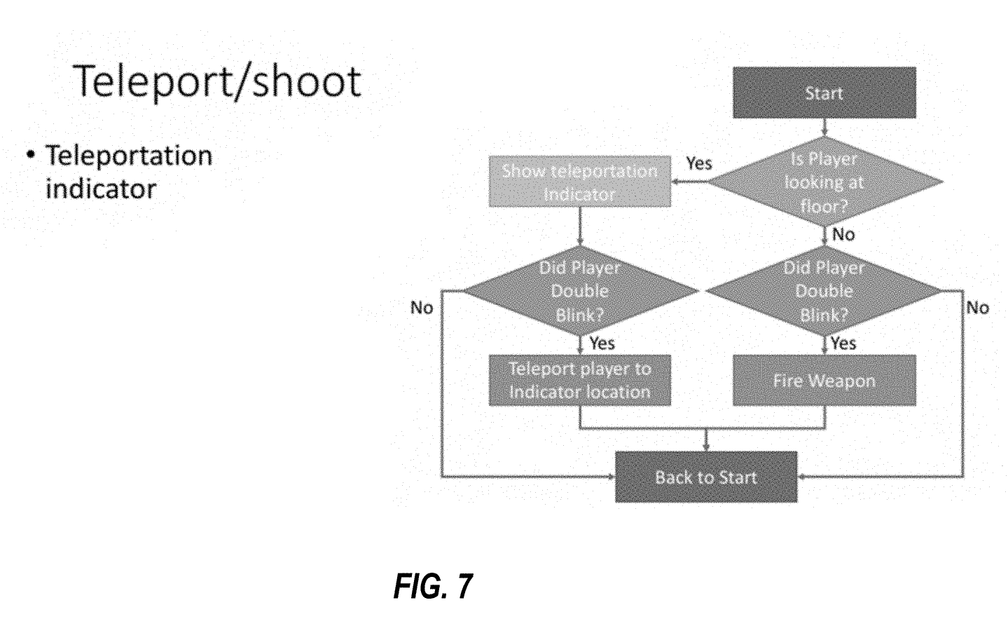

FIG. 7 shows a mechanism for combining and deciding between the methods in FIG. 6B and FIG. 4B, according to aspects of the present disclosure. In this example, gaze is used as a decision mechanism to decide between shooting a gun or teleporting the player, which may be referred to as a player gaze decision mechanism. An indicator is also used for identifying where the player's gaze meets the floor for identifying the location where the player would teleport. While double blinking is used as a biometric trigger for triggering the action, the action of the player is selected according to the player gaze decision mechanism. That is, the player navigates the VR environment by directing his gaze to the teleport location on the floor and doubling blink for teleporting to the teleport location. Otherwise, the player may look away from the floor towards, for example, a target, and double blink to shoot the target.

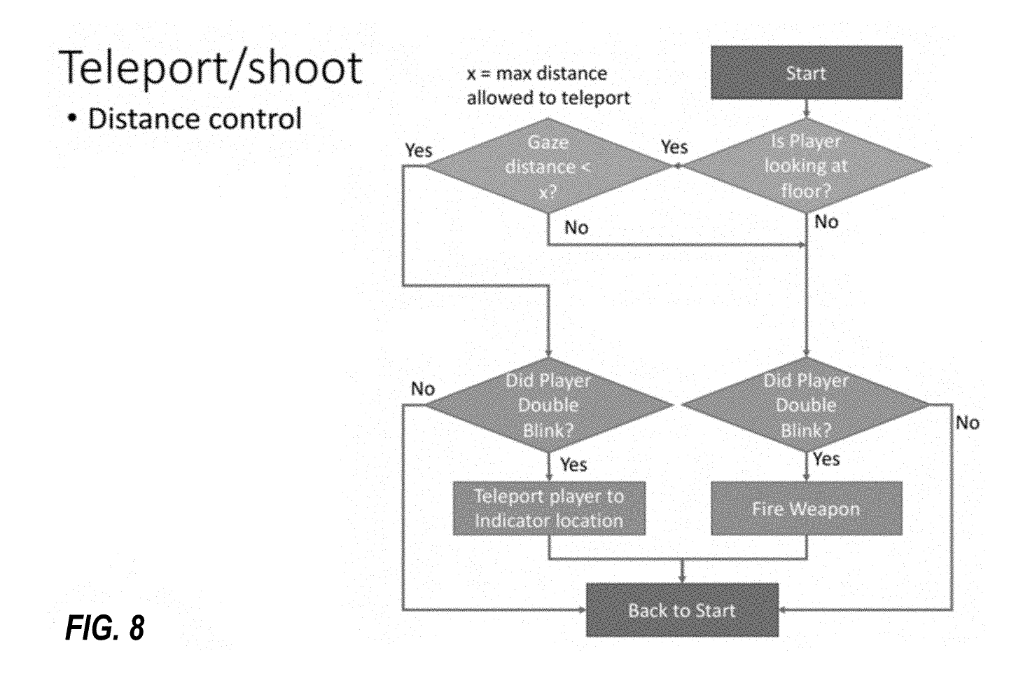

FIG. 8 modifies FIG. 7 by adding a distance control decision mechanism, according to aspects of the present disclosure. This allows the player to fire their weapon instead of teleporting when looking at the floor if it is farther than a distance x away. In this example, the distance x defines a maximum teleporting distance. When a player's gaze is greater than the maximum distance x, the player teleport mechanism is disabled. In this case, a double blink by the player will trigger firing of a weapon.

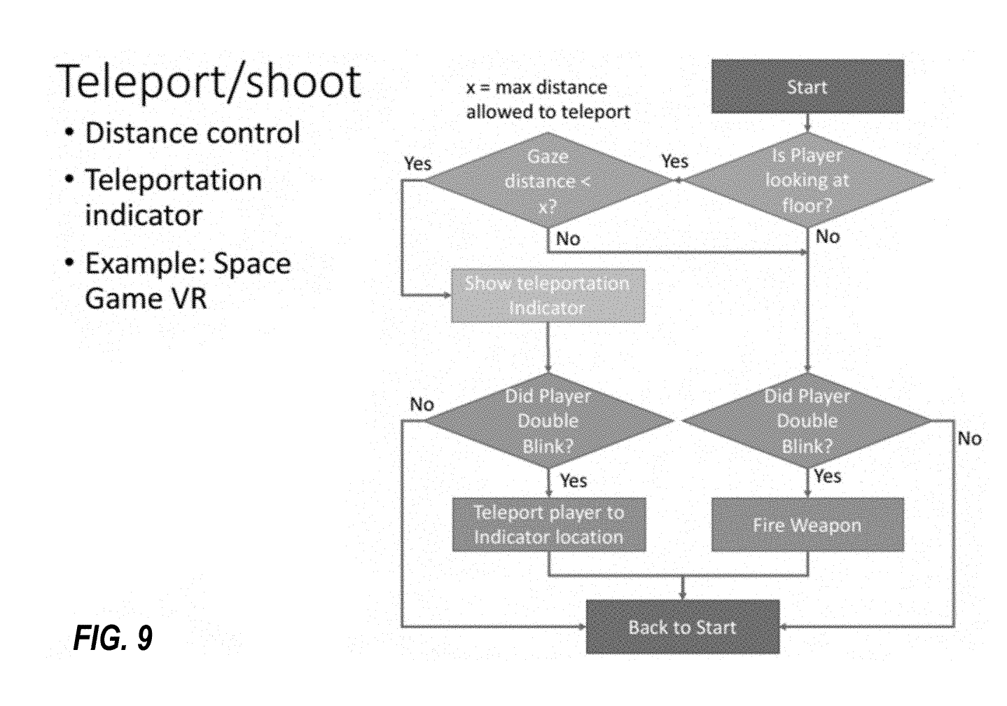

FIG. 9 modifies FIG. 8 by adding an indicator to let the player know when and if they can teleport, for example, using the double blink trigger mechanism, according to aspects of the present disclosure. In this example, a player is provided an indicator when gazing at the floor less that the distance x away. That is, when the indicator is present, the player understands that the teleport mechanism is enabled. As a result, navigation within a VR environment is improved, according to the indicator mechanism of FIG. 9.

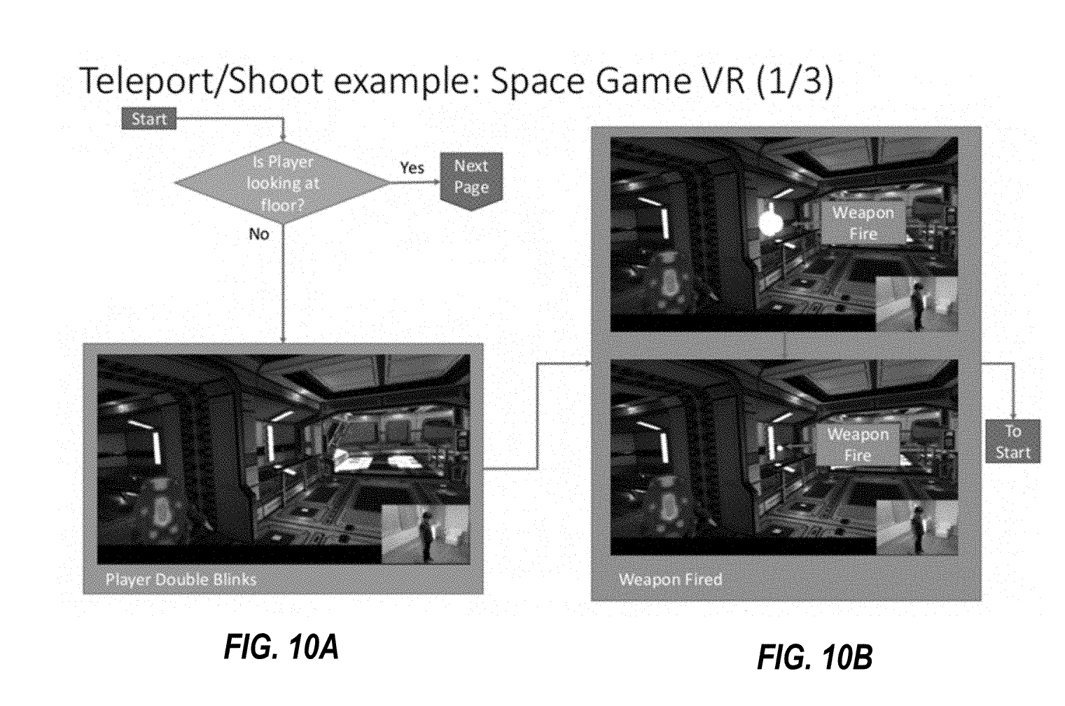

FIGS. 10A, 10B, 11A, 11B, and 12 show an exemplary VR game, as an implementation of the indicator mechanism of FIG. 9, according to aspects of the present disclosure. FIG. 10A shows the player firing their weapon using an eye-blink control mechanism (e.g., a double blink), when not looking at the floor. In this example, the player averts his gaze from the floor to a target on the left wall of a room in the VR game to shoot a target, as shown in FIG. 10B.

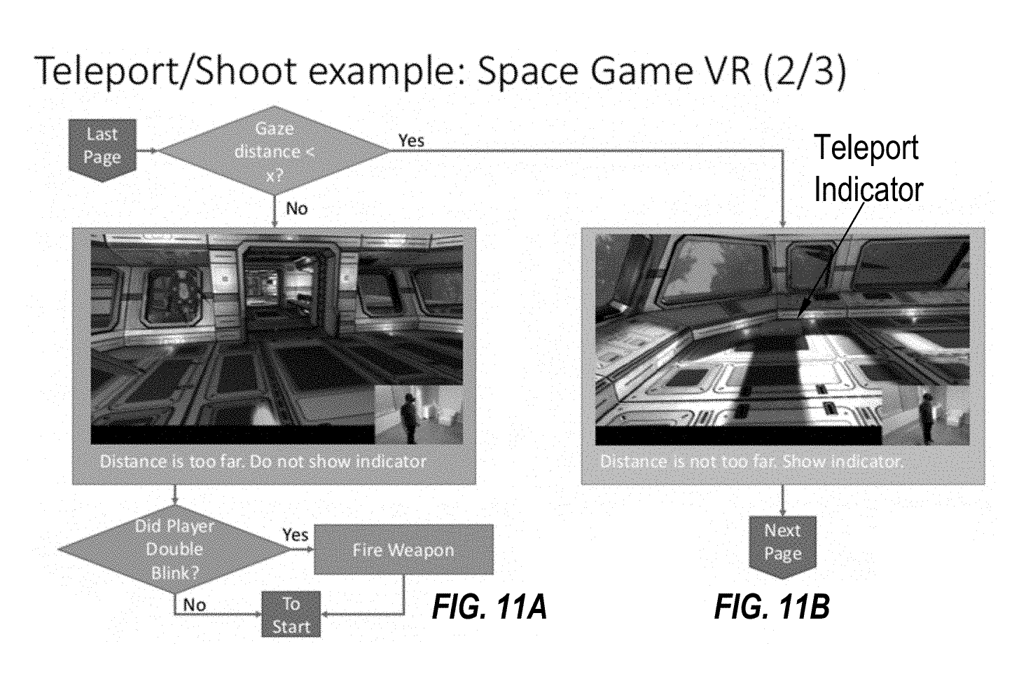

FIGS. 11A and 11B shows the decision-making process for the gaze distance (near or far), as well as an indicator for teleportation location, according to aspects of the present disclosure. In this example, a gaze of the player is initially greater than the maximum teleport distance x, so the teleport mechanism is disabled, as shown in FIG. 11A. As further illustrated in FIG. 11B, an indicator appears on the floor once the user's gaze on the floor is less than the maximum teleport distance x.

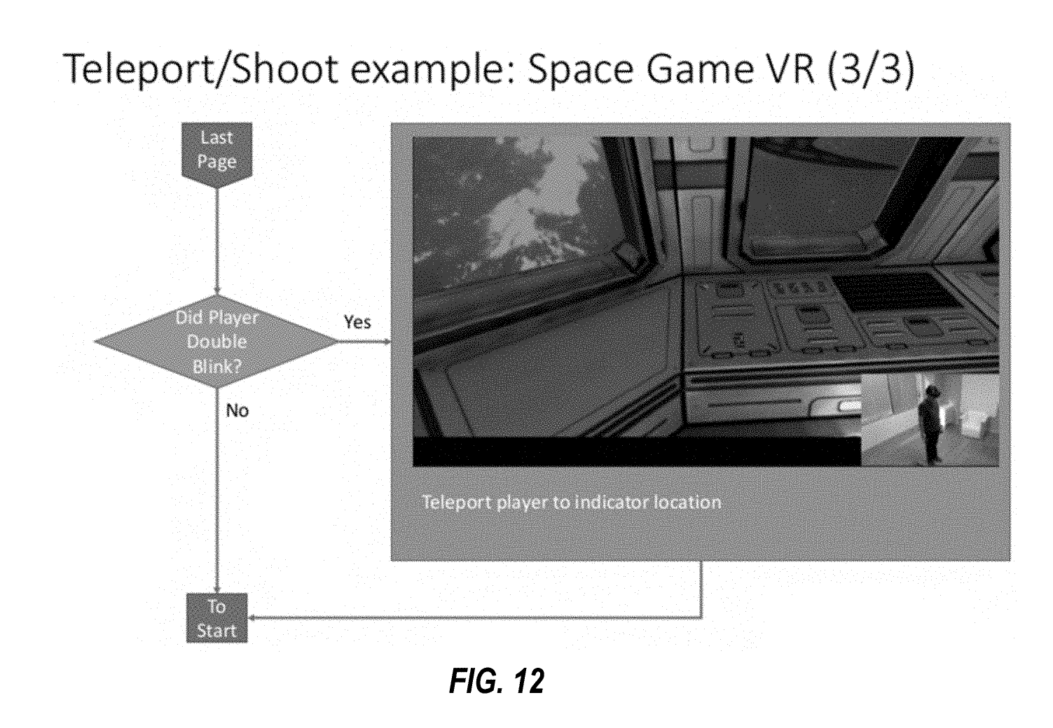

FIG. 12 shows the new location of the player after double blinking and triggering teleporting to the teleport indicator location. In this configuration, the “teleport/shoot” actions are being selected by head position—gaze and driven by detection of muscle (e.g., eye blink) biometric signals as a biometric feature detection control. In other words, head position—gaze is determining the selection between teleporting or shooting, and eye-blink control is triggering that action selection, enabling motion and/or shooting control within the VR game.

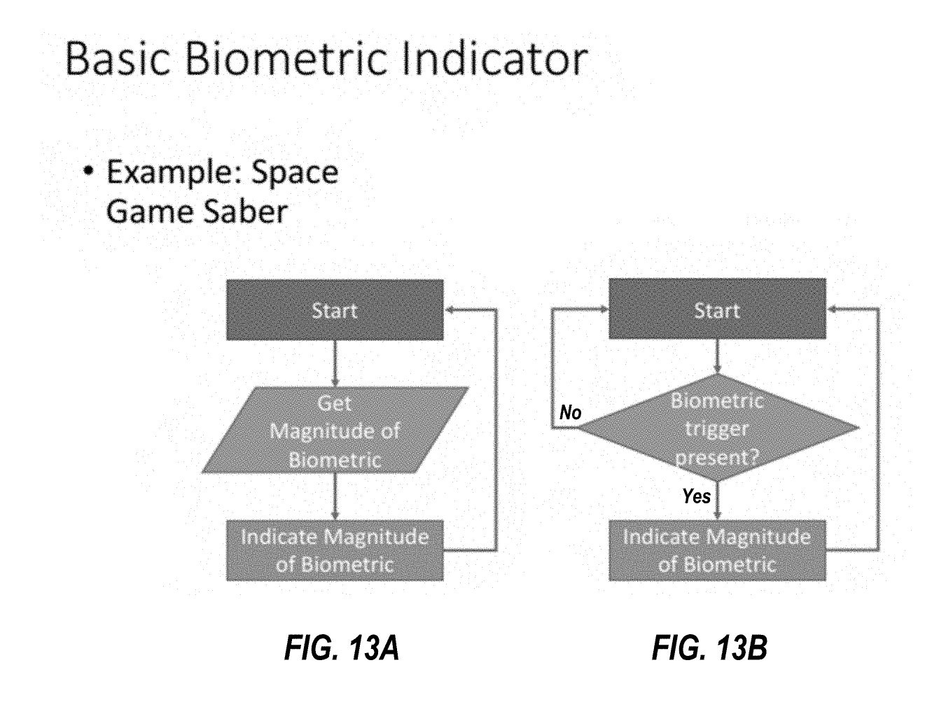

FIG. 13A shows a block diagram of a basic biometric indicator using a biometrics' magnitude methodology, and FIG. 13B shows a basic biometric indicator that involves a trigger, according to aspects of the present disclosure. FIGS. 13A and 13B provide examples in which biometric signals are used for providing a control metric that performs a spectral power and/or amplitude analysis for assessment of a signal component magnitude. FIG. 13A shows a block diagram basic biometric indicator using a biometrics' magnitude methodology. One such example of a feature is eye blinking. FIG. 13B shows a basic biometric indicator that involves a trigger, such as: double blinking, biometric magnitude above a certain level, or a detection of a users' specific mental state.

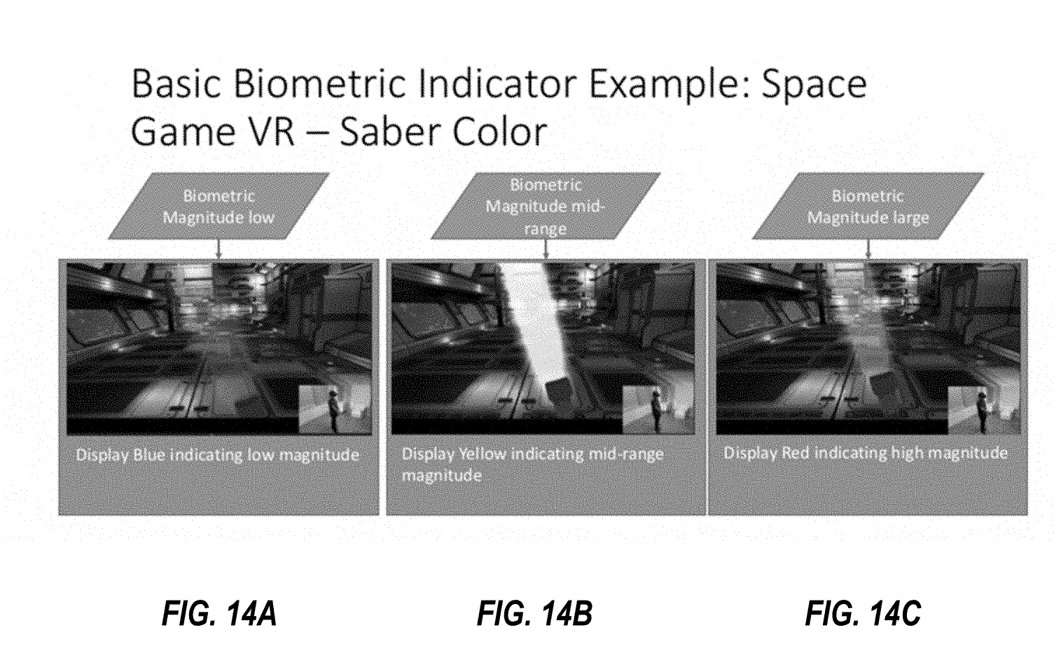

According to aspects of the present disclosure, the use of the magnitude of a player's focus state, as determined by their electroencephalography (EEG), is used to change the color of a saber in virtual reality, as shown in FIGS. 14A-14C and described in FIG. 13A.

FIGS. 14A-14C show examples of FIGS. 13A and 13B, with screenshots showing detecting of a magnitude change (from an EEG spectral analysis) leading to an observable correlated modification of an attribute (e.g., color) of an object in an exemplary VR game, according to aspects of the present disclosure. FIGS. 14A-14C show the detecting of a magnitude change (e.g., from an EEG spectral analysis) as a biometric control metric. In this aspect of the present disclosure, detecting a magnitude change leads to an observable correlated modification of the color of an object in an exemplary VR game. In aspects of the present disclosure, indicated colors and subsequent color indicators colors or indicators may have discrete cut-offs/activations or be on a smooth spectrum.

In this configuration, the aspect changes of the object (e.g., color of the saber) is driven by EEG spectral frequency modulations functioning as a biometric magnitude control. In other words, neural biological control is driving the aspect changes of an object in the game/interactive environment. For example, as shown in FIG. 14A, the biometric magnitude of the user is low (e.g., the player is distracted), resulting in the display of, for example, a blue color as the color of the saber. As shown in FIG. 14B, the biometric magnitude of the user is mid-range (e.g., the player is slightly distracted), resulting in the display of, for example, a yellow color as the color of the saber. As shown in FIG. 14C, the biometric magnitude of the user is high (e.g., the player is focused), resulting in the display of, for example, a red color as the color of the saber. Although the biometric magnitude is based on a detected level of player focus using the biometric control device, other metrics are also possible according to aspects of the present disclosure. For example, other metrics can include muscle activations in the face, relaxation, ERP (event-related potential) performance, and/or blink rate. These other metrics may also influence other indicators such as sound, game difficulty, environmental lights, and/or environment states.

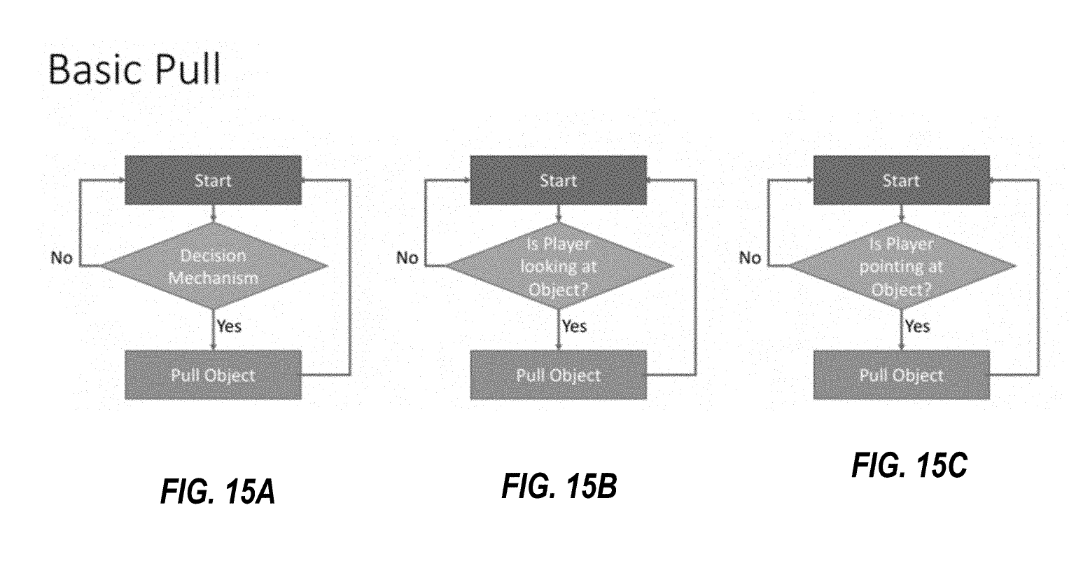

FIGS. 6A-12 describe a teleport mechanism for navigating the VR environment using various biometric triggers. While the teleport mechanism improves navigation in a VR environment, interaction, such as accessing objects, is also problematic in VR environments. FIGS. 15A-20B describe mechanisms for accessing (e.g., pulling) objects in a VR environment by using various biometric triggers, according to aspects of the present disclosure.

FIG. 15A shows a block diagram for motion control to pull an object towards a player using a decision mechanism, according to aspects of the present disclosure. In this example, a basic mechanism is described for pulling an object towards a player using a decision mechanism. Unfortunately, selecting the object to pull can be problematic using conventional pulling mechanisms.

FIG. 15B shows an example of FIG. 15A, in which a player's gaze is used as a decision mechanism for improving the pulling mechanism of FIG. 15A, according to aspects of the present disclosure. In this example, a biometric control device monitors eye movement of the player for tracking the player's gaze. The biometric control device may use the player's gaze as a decision mechanism for identifying and pulling an object in the VR environment. In one example, a timer may be added so that a user simply wants to observe an object, but the user does not desire to pull the object.

FIG. 15C shows an example of FIG. 15A using a gesture, hand location, or controller orientation to check if the player is pointing at an object as a decision mechanism, according to aspects of the present disclosure. Representatively, a player's gesture, hand location, or controller orientation is used to check if the player is pointing at an object as a decision mechanism. Once the biometric control device determines that the player is pointing at an object, the object is pulled toward the player. A timer may also be added so that a user simply wants to point to an object, but the user does not desire to pull the object. For example, an object is pulled if the user gazes/points at the object for a predetermined number of seconds.

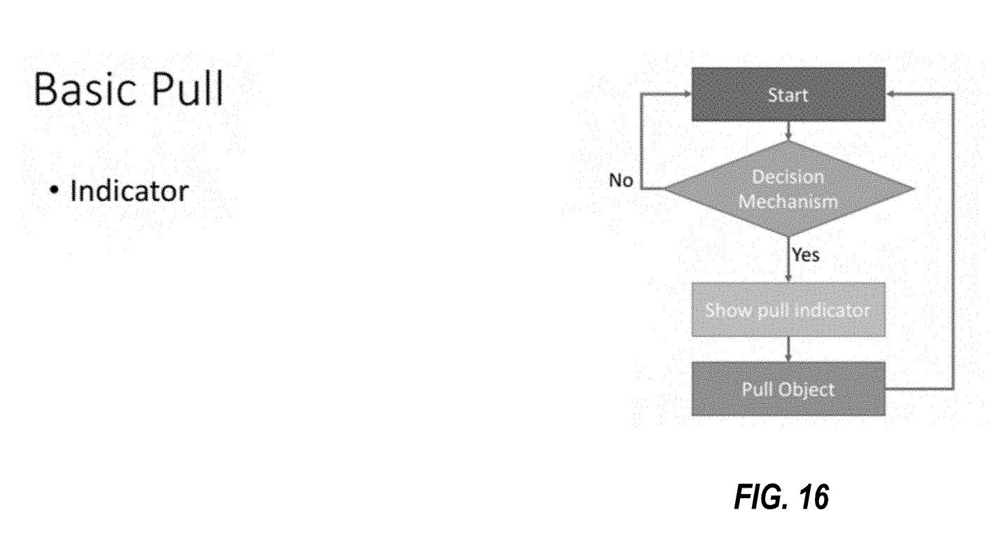

The pull mechanisms described in FIGS. 15A-15C, however, do not provide an indicator that an object is being pulled, prior to pulling the object. FIG. 16 expands FIGS. 15A-15C by adding an indicator to inform the player that an action is taking place or can take place, according to aspects of the present disclosure. In this example, a visual indicator may be displayed for letting the user know that the action is taking place or can take place.

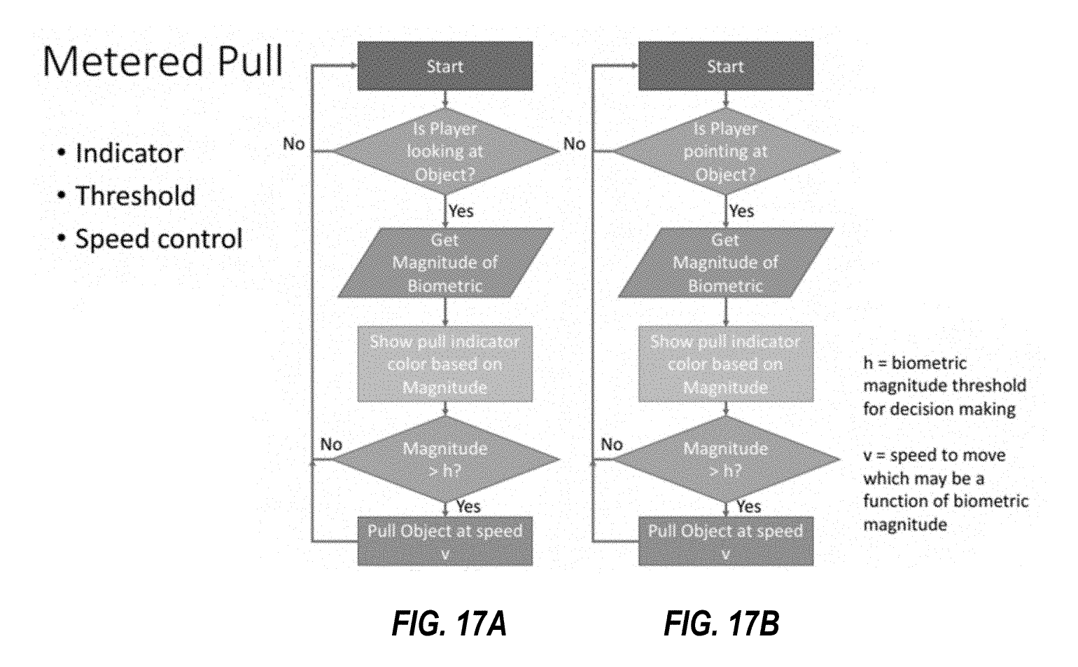

FIGS. 17A-20B provide further expansions of pulling mechanisms, according to aspects of the present disclosure. In these configurations, biometric signals may be used for providing a control metric that performs a spectral power and/or amplitude analysis for assessing a signal component's magnitude. One such example is using the magnitude of a players focus state, as determined by their EEG to change a color of a saber in a VR environment, for example, as shown in FIGS. 14A-14C and described in FIG. 13A. The biometric signals may also be used to provide a control metric that performs analysis to detect physiologically relevant states of the user. In aspects of the present disclosure, the biometric signals may be used to apply state and feature analysis to determine closeness on an actionable scale.

FIGS. 17A and 17B expand the pulling mechanism of FIGS. 15B and 15C, respectively, by adding a biometric operator, an indicator, and threshold control, according to aspects of the present disclosure. In this example, the speed of the pull may be related to the magnitude of the desired biometric control. For example, the last decision checks the magnitude of the biometric control against a variable and specifies the magnitude of the biometric to be greater than the variable to enable the object to be pulled. In this example, the indicator could come before or after the magnitude decision mechanism. The magnitude decision mechanism could also specify the biometric magnitude to be less than the variable. The variable can also be zero (0) and allow any magnitude to pass the comparison test.

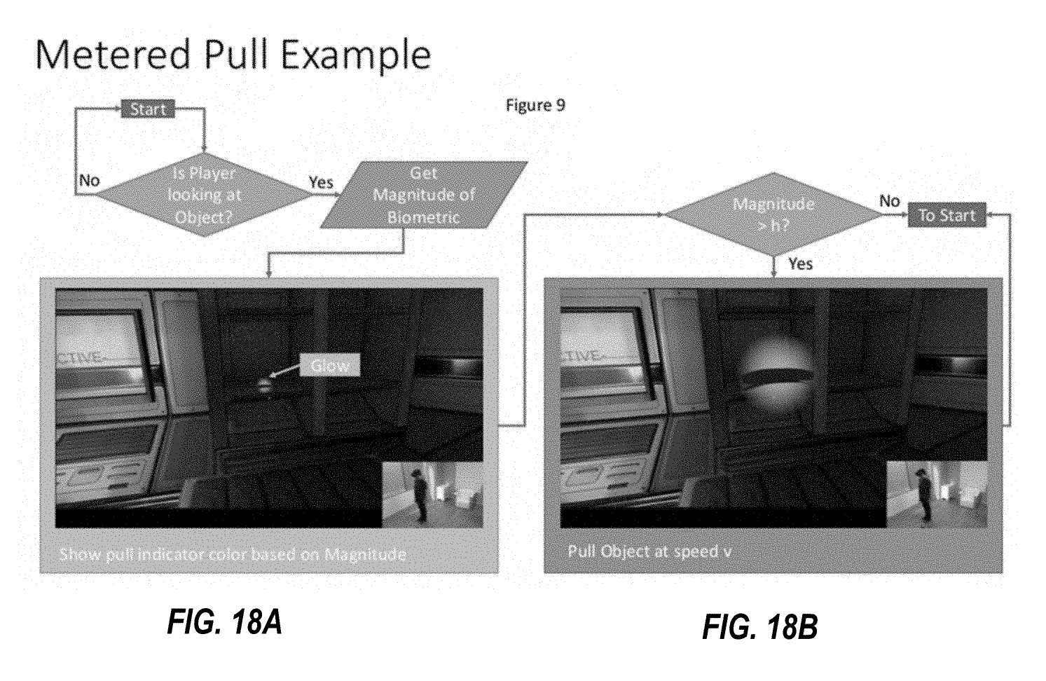

FIGS. 18A and 18B show an exemplary VR game, as a configuration of FIG. 17A with screenshots, according to aspects of the present disclosure. As shown in FIG. 18A, a glowing light is used as an indicator to show that the player is pulling the object. This indicator may change color based on its magnitude, as depicted in FIGS. 14A-14C. FIG. 18B is an action screenshot, showing the object getting closer to the player.

In this configuration, the “motion control” is being driven by determined state changes in the user's mental state. In aspects of the present disclosure, changes in the user's mental state may be determined by modulations and correlations in different EEG spectral frequency bands functioning as a biometric magnitude control. For example, brain waves may be broken down into predetermined frequency bands. In addition, predetermined power values may be assigned to the frequency bands to provide a biometric magnitude control.

In this aspect of the present disclosure, neural biological control, determined as a user's state of focus or relaxation, is a driving motion of an object in the game/interactive environment. In one aspect of the present disclosure, spectral patterns from EEG signals of the user's mental state may be compared with predetermined spectral patterns for different states of mind. The predetermined spectral patterns for different states of mind may be determined during testing phases or other like procedure for categorizing and identifying different mental states according to brain waves. In this example, a user's current mental state is compared to the predetermined spectral patterns for determining an analysis score indicating how close the user's mental state is to the predetermined spectral patterns. This analysis score may then be used to drive decisions as well determine environmental characteristics of the user's virtual/digital environment. For example, this process may include modifying displayed attributes of the environment of the user according to the mental state of the user.

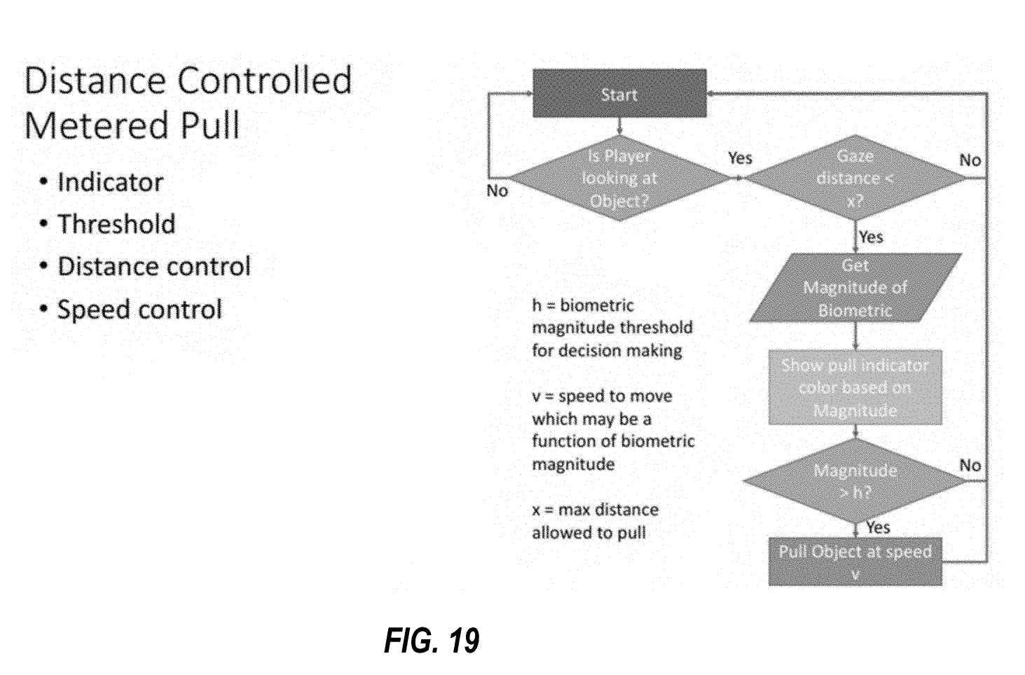

FIG. 19 expands FIG. 17A by adding a decision that specifies a player being within a certain distance to pull an object using a biometric magnitude, according to aspects of the present disclosure. This example describes a distance controlled metered pull of an object based on a biometric magnitude. For example, the player's gaze is analyzed to ensure the player is looking at an object that is less than a maximum gaze distance way. When this condition is satisfied, a biometric magnitude of a player state is acquired. Next, an indicator is presented to the player for identifying an object, in which a color of the indicator communicates the biometric magnitude of the player state (e.g., a player focus level). In this case, if the biometric magnitude is less than a biometric magnitude threshold h, the object is not pulled. Otherwise, the object is pulled at a speed v, which may be a function of the biometric magnitude.

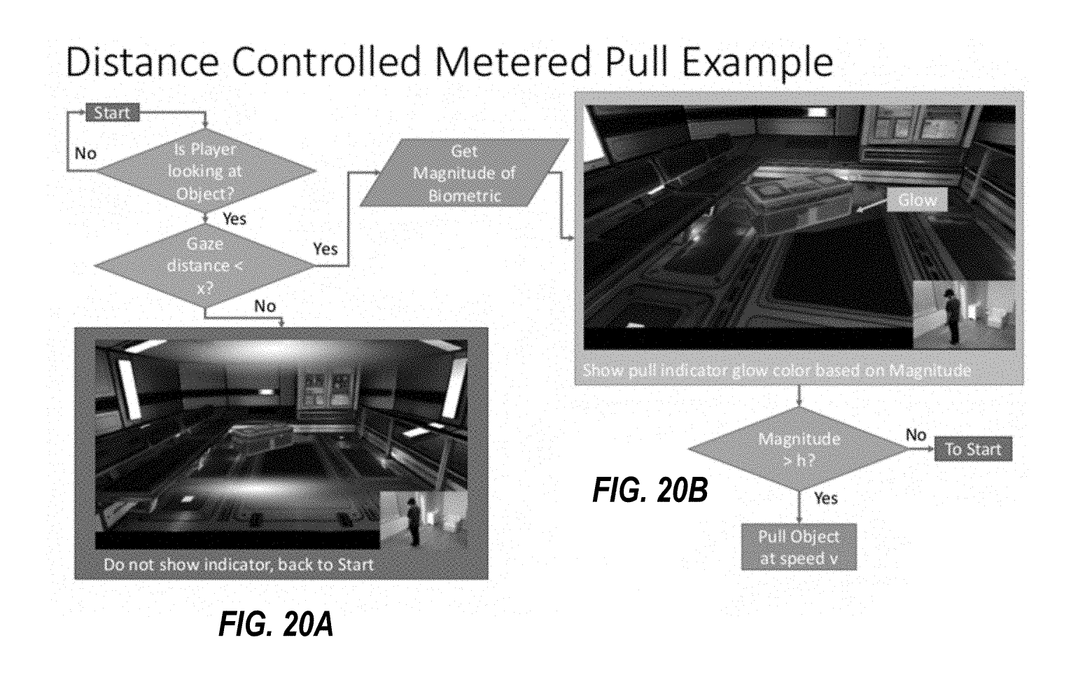

FIGS. 20A and 20B show an exemplary VR game, as a configuration of FIG. 19, according to aspects of the present disclosure. FIG. 20A shows a player being too far away to pull an object, while FIG. 20B shows a glow indicator when the player is within range. In the configuration as shown in FIG. 20B, the “pulling motion” is being driven by determined state changes in the user's mental state. As noted, mental state changes may be determined by modulations and correlations in different EEG (electroencephalography) spectral frequency bands functioning as a biometric magnitude control. In other words, neural biological control, determined as a user's state of focus or relaxation is driving motion of an object in the game/interactive environment. As noted above, EEG spectral frequency patterns of the user may be compare with predetermined spectral frequency patterns. In this example, an analysis score may indicate a level of similarity between the user's EEG spectral frequency patterns and the predetermined spectral frequency patterns.

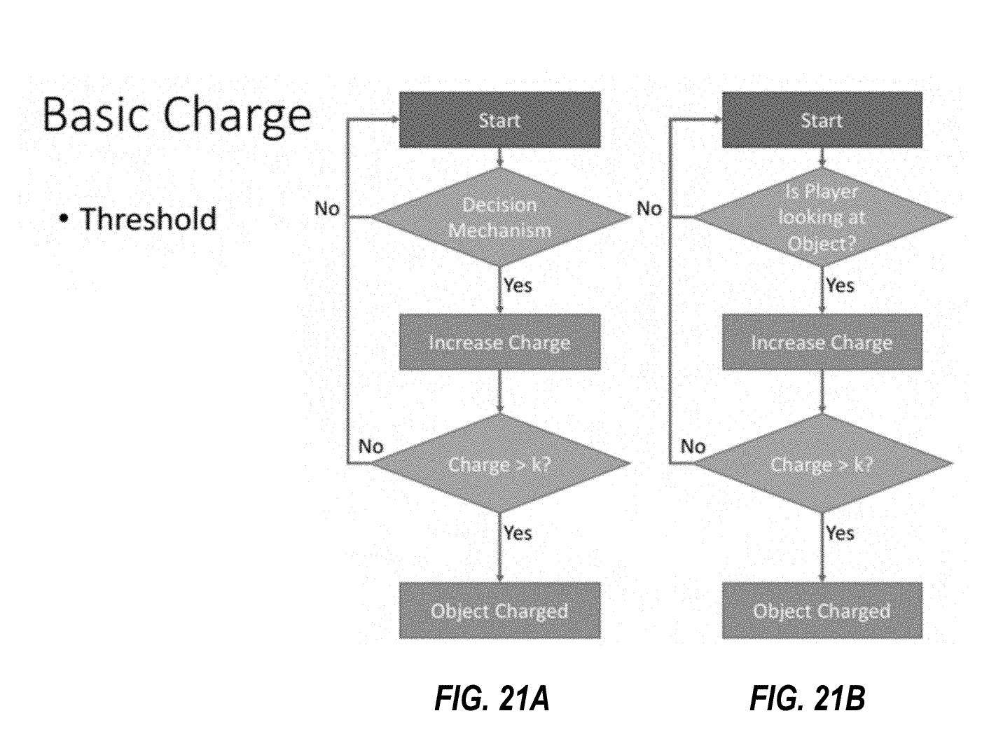

FIG. 21A shows a basic block diagram for charging an object. FIG. 21B shows a block diagram where player gaze is used as a decision mechanism for charging an object, according to aspects of the present disclosure. An indicator may be used to indicate level of charge at any point in the diagram. Once an object's charge is high enough, the object is considered charged and may change state. For instance, a charged battery may activate a door, portal or allow a player to use a certain weapon in the game. In other words, charge may indicate a state of charge of an electronic device or an explosive capability of a weapon depending on the game environment.

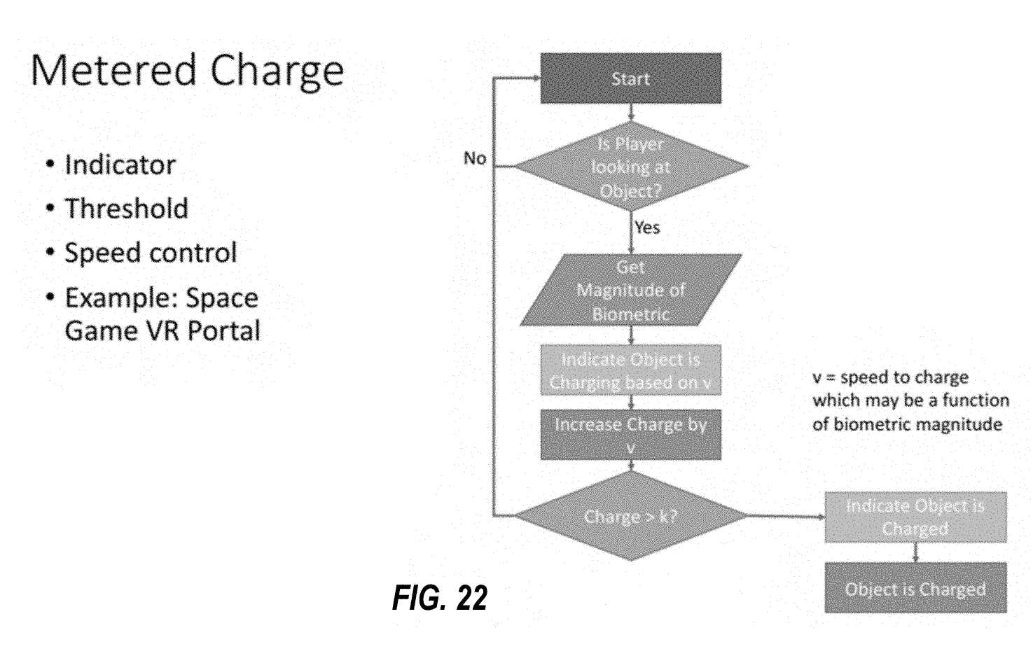

FIG. 22 expands FIG. 21B by augmenting the charging by enabling charging speed control by biometric magnitude, according to aspects of the present disclosure. In this example, once the player is identified as looking at an object, a magnitude of a biometric control signal is determined. In this case, the object is charged at a speed v, which is determined by the magnitude of the biometric control signal. This process is repeated until a charge level of the object is greater than a predetermined charge level k. Once charged, an indicator is provided for informing the player that the object is charged. The biometric magnitude may be switched for a biometric trigger or any other control metric. An indicator is also added that may display current charge level or rate of charging. An additional indicator may also be added to show that the object is charged in this example.

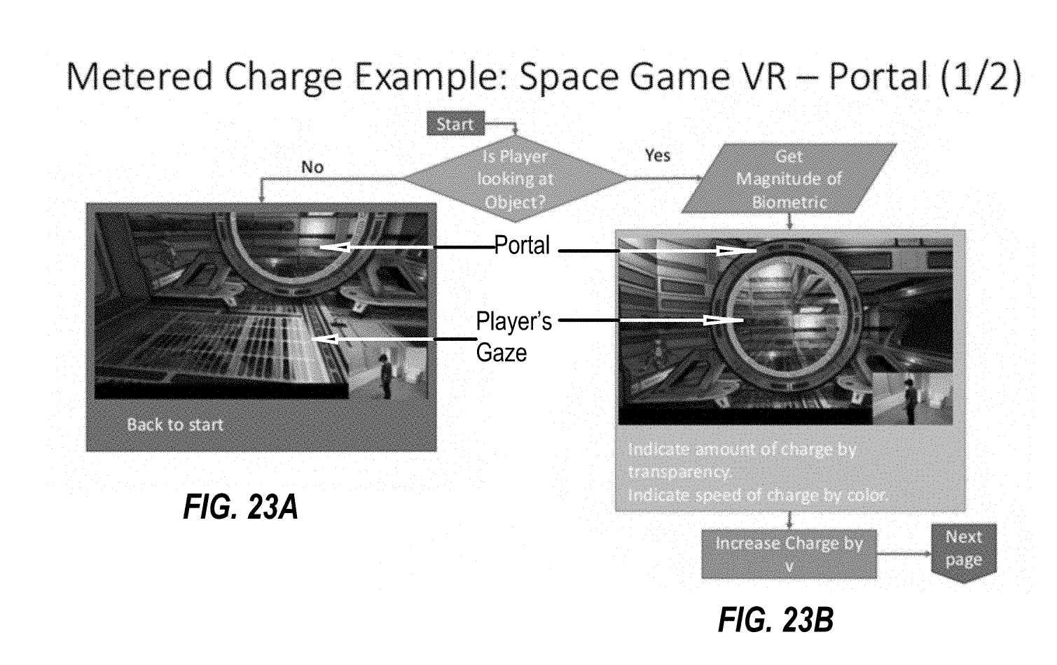

FIGS. 23A and 23B show a first part of an example with the flowchart of FIG. 22 in an exemplary VR game, according to aspects of the present disclosure. In this example, a player may look at a portal to charge it. FIG. 23A depicts what happens when the player does or does not look at the portal, but instead looks at the floor, as indicated by the player's gaze. FIG. 23B illustrates an example of a charging mechanism indicating when the portal is being looked at by the player.

In this configuration, the “charging” is being driven by power changes in different EEG spectral frequency bands functioning as a biometric magnitude control. In other words, neural biological control is also driving the charging. In this example, the color indicator may indicate a slower charge due to a reduced magnitude of the player's mental state (e.g., a less focused mental state). Alternatively, environmental changes may be triggered by the player's mental state. These environmental changes may include passive things like blooming a flower or causing grass to wilt or changing how stormy a sky appears in the user's virtual/digital world.

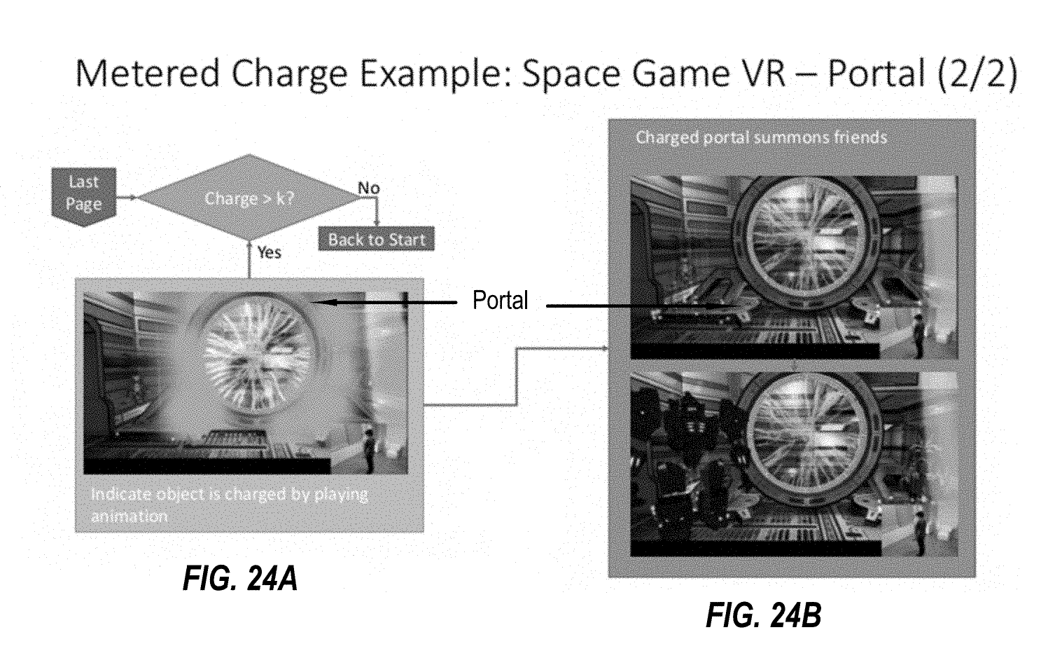

FIGS. 24A and 24B show the second and last part of an example with the flowchart of FIG. 22 in an exemplary VR game, according to aspects of the present disclosure. As shown in FIG. 24A, the player looks at a portal to charge the portal. FIG. 24B also displays an animation as an indicator of when the portal is completely charged. In the example of FIG. 24B, the charged portal changes state once charged. This feature may enable automatic addition of new players to the game, such as starting a multiplayer mode. In this configuration, the “charging” is also being driven by power changes in different EEG spectral frequency bands functioning as a biometric magnitude control. In other words, neural biological control is also driving the charging and enabling of a multiplayer mode.

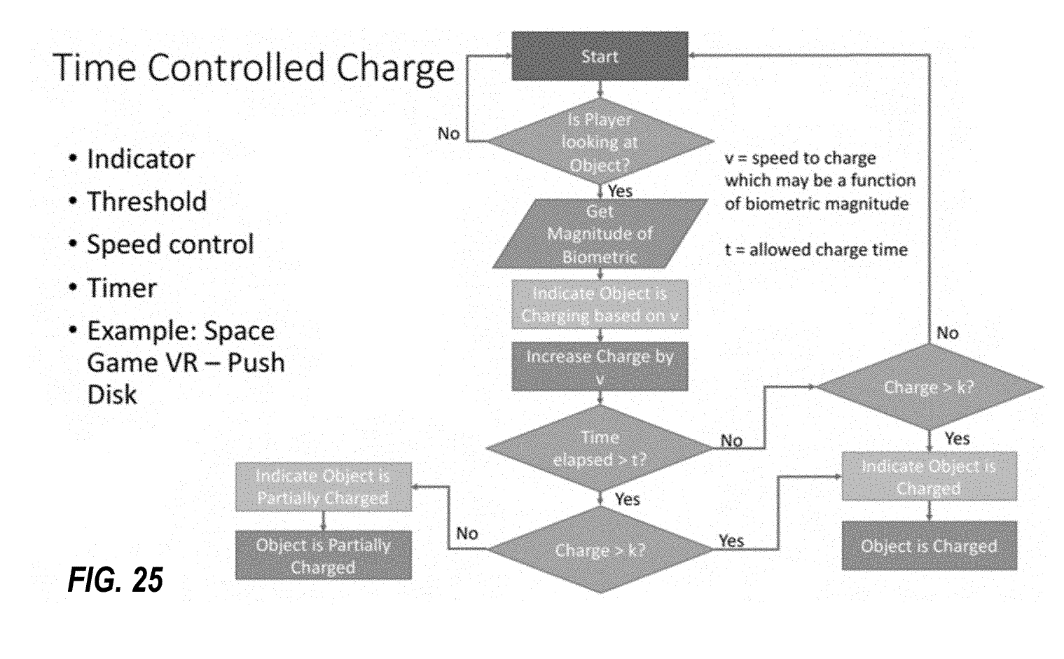

FIG. 25 is a flowchart that modifies the charging mechanism as shown in FIG. 22 by giving a time limit for charging an object, according to aspects of the present disclosure. In this example, the time controlled charge supplies a time limit for charging an object, which may test the player's gaming proficiency. The flowchart of FIG. 25 modifies the charging mechanism of FIG. 22 by inserting a decision block before checking the charge level of the object. In this example, the player is limited to an allowed charge time t for charging an object. As the player's proficiency in the VR game increases, the player eventually is able to charge the object within the allowed time to charge t.

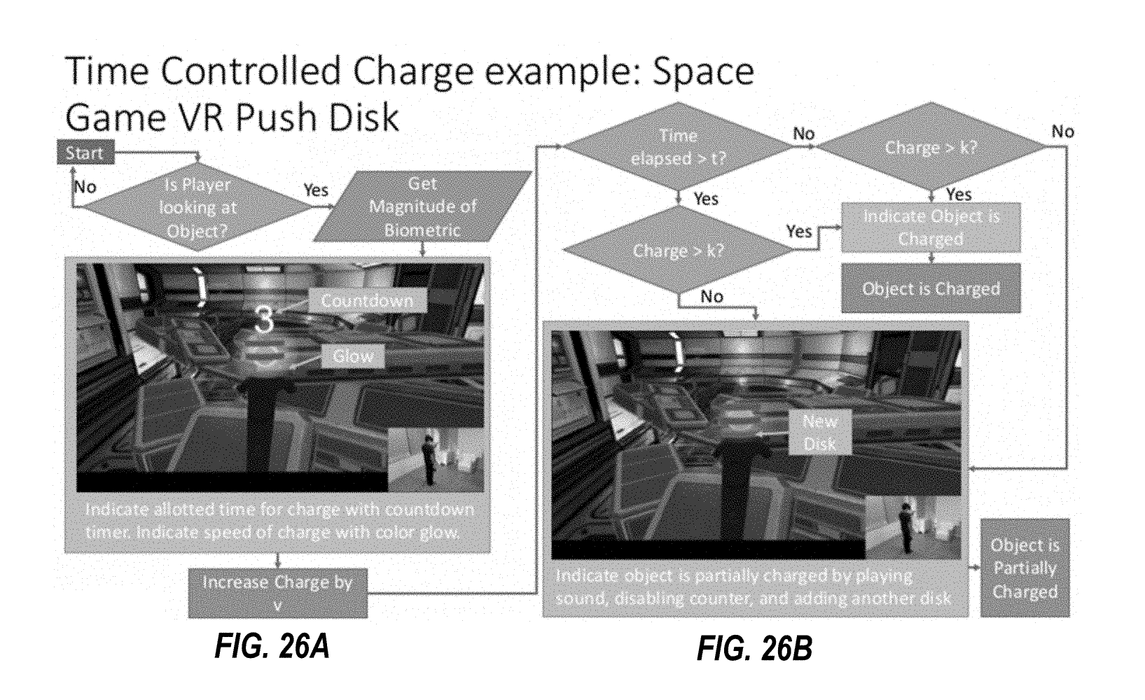

FIGS. 26A and 26B show a time controlled charge in accordance with the flowchart of FIG. 25 in an exemplary VR game, according to aspects of the present disclosure. As shown in FIG. 26A, the player is charging an object, as indicated by a glow. A countdown (e.g., 3) is also displayed to the player, indicating the allotted time for charging the object. In this example, a color of the glow may indicate a charging speed v of the object, which varies, according to a biometric control as described above. FIG. 26B illustrates a partial charge of the object by illustrating a shape (e.g., a new disk). An indication of a partial charge may be provided by playing a sound, disabling the counter, and/or adding the new disk.

Referring again to FIGS. 1A and 1B, an indicator may be anything that gives information to the player based on a decision mechanism or control metric. Indicator configuration can typically be: (1) visual; (2) auditory; and/or (3) tactile. For example, a visual indicator, such as presence, color, light, glow, size, or other appearance changes or displays may provide an indication to the player. One example of a visual indicator is shown in FIGS. 14A-14C, in which the color of a saber indicates the magnitude of a biometric control signal (e.g., a user's focus level). FIGS. 23A and 23B show the decision-making process for the gaze distance (near or far), as well as an indicator for teleportation location, according to aspects of the present disclosure. In this example, the indicator is present when the player is looking at the floor (and close enough). Conversely, the indicator is not present when the player is not looking at the floor (or if the player is looking at the floor but the floor is too far away and/or if the player is looking at the floor but is out of range to teleport).

In other inventive aspects, an auditory indicator may be represented by an audio output such as speech, beeps, buzzes, ambient noises/sounds or other sound effects. In addition, a tactile indicator may be provided to the player in the form of vibration of a controller or other haptic responses. Indicators can present various modifying features such as: presence/absence, length, size, volume, brightness, texture, etc.

According to an aspect of the present disclosure, a biometric control device is described. In one configuration, the biometric control device includes means for detecting a biometric signal from a user in an environment. For example, the detecting means may be the data acquisition unit of FIGS. 2A and/or 2B. In one configuration, the biometric control device includes means for modulating a set of actions and/or objects in the environment according to the biometric signal detected from the user. For example, the modulating means may be the data processing unit of FIGS. 2A and/or 2B. The biometric control device may also include means for sensing a brain signal (EEG), a muscle signal (EMG), and/or a behavioral response of the user. The sensing means may be the data acquisition unit of FIGS. 2A and/or 2B. In another aspect, the aforementioned means may be any module or any apparatus or material configured to perform the functions recited by the aforementioned means.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD) and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized, according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), and Blu-ray disc where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “a step for.”

What is claimed is:

1. A method of a biometric control system, comprising:
detecting a first biometric signal from a first user in an environment; and
modulating a set of actions and/or objects in the environment according to the first biometric signal detected from the first user.

2. The method of claim 1, in which detecting the first biometric signal comprises sensing a brain signal (EEG), a muscle signal (EMG), and/or a behavioral response of the first user.

3. The method of claim 2, in which the behavioral response comprises an eye movement and/or a facial movements.

4. The method of claim 1, in which modulating the set of actions comprises teleporting the first user to a selected location within the environment in response to the first biometric signal detected from the first user.

5. The method of claim 1, in which modulating the set of actions comprises firing a weapon within the environment in response to the first biometric signal detected from the first user.

6. The method of claim 1, in which the first biometric signal detected from the first user comprises an eye-blink of the first user.

7. The method of claim 1, in which modulating the set of actions comprises determining an analysis score based on at least a magnitude of an attribute selected by the first user according to the first biometric signal detected from the first user.

8. The method of claim 7, in which the analysis score based on the magnitude of the attribute selected by the first user is indicated by a color used to display the attribute selected by the first user.

9. The method of claim 7, in which the analysis score based on the magnitude of the attribute selected by the first user is indicated by a shape associated with the attribute selected by the first user.

10. The method of claim 7, in which the analysis score based on the magnitude of the attribute selected by the first user is indicated by a sound associated the attribute selected by the first user.

11. The method of claim 1, in which modulating the set of actions comprises determining a mental state of a second user according to a second biometric signal detected from the second user in a multi-user mode.

12. The method of claim 11, further comprising modifying displayed attributes of the environment of the first user according to the mental state of the second user in the multi-user mode.

13. A biometric control device, comprising:
a data acquisition unit configured to detect a biometric signal from a user in an environment; and
a data processing unit configured to process the biometric signal detected from the user to compute a biometric control signal configured to modulate a set of actions and/or objects in the environment.

14. The biometric control device of claim 13, in the data acquisition unit is configured to sense a brain signal (EEG), a muscle signal (EMG), and/or a behavioral response of the user as the biometric signal.

15. The biometric control device of claim 14, in which the behavioral response comprises an eye movement and/or a facial movements.

16. The biometric control device of claim 13, in which the set of actions comprises teleporting the user to a selected location within the environment in response to the biometric control signal.

17. The biometric control device of claim 13, in which the set of actions comprises firing a weapon within the environment in response to the biometric control signal.

18. The biometric control device of claim 13, in which the data processing unit is further configured to determine an analysis score based on at least a magnitude of an attribute selected by the user according to the biometric control signal.

19. The biometric control device of claim 13, in which the data processing unit is further configured to determine a mental state of the user according to the biometric signal detected from the user.

20. A biometric control system, comprising:
means for detecting a biometric signal from a user in an environment; and
means for modulating a set of actions and/or objects in the environment according to the biometric signal detected from the user.
